(19) United States
(12) Patent Application Publication
(10) Pub. No.: US 2024/0222821 A1
(43) Pub. Date: Jul. 4, 2024

(54) SENSORS FOR BATTERY PROTECTION

(71) Applicant: BAE Systems Controls Inc., Endicott, NY (US)

(72) Inventors: Michael Mallery, Apalachin, NY (US); Laura Dionisio, Endicott, NY (US); Matthew S. Boecke, Endicott, NY (US); Brian Cortes, Endicott, NY (US); Robert J. Arbogast, Binghamton, NY (US)

(73) Assignee: BAE Systems Controls Inc., Endicott, NY (US)

(21) Appl. No.: 18/093,140

(22) Filed: Jan. 4, 2023

(51) Int. Cl. H01M 50/578; H01M 10/42; H01M 10/48; H01M 50/342

(52) U.S. Cl. CPC H01M 50/578; H01M 10/425; H01M 10/48; H01M 50/3425; H01M 2010/4278; H01M 2200/20

(57) ABSTRACT

A battery assembly includes an enclosure, an outgas sensor within the enclosure, a pressure relief device within the enclosure, a pressure relief sensor within the enclosure, and a processor within the enclosure. The outgas sensor is configured to sense an outgas event of one or more battery cells within the enclosure and output a first sense signal. The pressure relief device is configured to release gas pressure from the enclosure, in response to pressure within the enclosure exceeding a threshold value. The pressure relief sensor is configured to sense a pressure release event caused by the pressure relief device and output a second sense signal. The processor is configured to receive the first sense signal and the second sense signal, and to transmit information associated with the first and second sense signals to a system that is external to the enclosure.

### TECHNICAL FIELD

The present disclosure relates generally to battery technology, and more specifically to sensors for protection of battery packs.

### BACKGROUND

A lithium-ion battery or Li-ion battery is a type of rechargeable battery with a high energy density and generally no memory effect. The batteries can be used individually, or together in groups that are packaged in a battery pack. Li-ion batteries and battery packs are commonly used in portable electronic devices (e.g., cell phones), electric vehicles, and cordless power tools for consumers, for example. The Li-ion battery is also used in military and aerospace applications.

The Li-ion cell provides electric current when lithium ions move through an electrolyte from a negative electrode to a positive electrode. Lithium ions move in the reverse direction when charging the cell. In some examples, the positive electrode includes lithium cobalt oxide (LiCoO₂), lithium iron phosphate (LiFePO₄), or lithium manganese oxide (LiMn₂O₄ or Li₂MnO₃). The negative electrode commonly includes graphite. The electrolyte can be a mixture of organic carbonates and lithium ion complexes. For example, the electrolyte can include ethylene carbonate or diethyl carbonate. Lithium ion cells can have a variety of form factors, including a cylinder, a flat, a pouch, and a rigid plastic case with threaded terminals. In one example, a cylindrical lithium-ion cell typically includes a metal container that provides the primary structure to the cell and serves as the negative electrode. The container can be made of aluminum or steel. An electrode assembly includes current collector sheets separated by porous membranes rolled into a cylindrical shape. The electrode assembly is placed in the container and functions as the electrical energy storage component. The current collectors may include copper or aluminum foil coated with an active material, and the porous membranes can be a polymer or ceramic. An electrolyte fills the remaining volume of the container and permeates the active material on the current collectors and separators. A cap, which serves as the positive electrode, is crimped in place on the top of the can to complete the cell and enclose the electrode assembly within the container. There remain several non-trivial issues with respect to operating lithium-ion battery packs.

### BRIEF DESCRIPTION OF THE DRAWINGS

FIG. 1 illustrates a battery assembly comprising a plurality of battery cells within an enclosure, where the battery assembly further includes (i) an outgas sensor within the enclosure, the outgas sensor configured to sense an outgas event of one or more battery cells and output a first sense signal, (ii) a pressure relief device within the enclosure, the pressure relief device configured to release gas pressure from the enclosure, in response to pressure within the enclosure exceeding a threshold value, (iii) a pressure relief sensor configured to sense a pressure release event caused by the pressure relief device and output a second sense signal, and (iv) a processor configured to receive the first sense signal and the second sense signal, and to transmit information associated with the first and second sense signals to a system that is external to the enclosure, in accordance with an embodiment of the present disclosure.

FIG. 2A illustrates a plot depicting a sense signal output by the outgas sensor of the battery assembly of FIG. 1, in accordance with an embodiment of the present disclosure.

FIG. 2B illustrates a plot depicting a sense signal output by the pressure relief sensor of the battery assembly of FIG. 1, in accordance with an embodiment of the present disclosure.

FIG. 3 illustrates detail of communication between the processor of the battery assembly of FIG. 1 and the system that is external to the enclosure, in accordance with an embodiment of the present disclosure.

FIGS. 4A and 4B illustrate the battery assembly of FIG. 1, along with operations of a switch within the enclosure of the battery assembly, where the switch is operable to disconnect the plurality of battery cells from a load external to the enclosure, in response to a detection of an outgas event and/or a pressure release event, in accordance with an embodiment of the present disclosure.

FIG. 5A illustrate a flowchart depicting a method for operating the battery assembly of FIGS. 1, 3, 4A, and 4B, where a switch for connecting and disconnecting the plurality of battery cells to a load is controlled by the processor that is within the enclosure, in accordance with an embodiment of the present disclosure.

FIG. 5B illustrate a flowchart depicting a method for operating the battery assembly of FIGS. 1, 3, 4A, and 4B, where the switch for connecting and disconnecting the plurality of battery cells to the load is controlled by the system that is external to the enclosure, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

Disclosed are methodologies and structures for mitigating propagation of thermal runaway in a battery assembly, such as a lithium-ion battery assembly. In accordance with some example embodiments, a battery assembly comprises an enclosure, and a plurality of battery cells within the enclosure. A pressure relief device (such as a burst disc device) is within the enclosure, where the pressure relief device is configured to release gas pressure from the enclosure (e.g., by way of rupture of a diaphragm of the burst disc), responsive to the gas pressure exceeding a threshold due to outgassing of one or more battery cells within the enclosure during a fault condition of the one or more battery cells. A pressure relief sensor within the enclosure is configured to output a pressure relief sense signal indicative of such a pressure relief event. An outgas sensor within the enclosure is configured to sense any outgassing within the enclosure, e.g., due to a fault condition of one or more battery cells, where the outgas sensor is configured to output an outgas sense signal indicative of any outgas event.

In some embodiments, a processor within the enclosure is configured to receive the pressure relief sense signal and the outgas sense signal. In some such embodiments, the processor may forward the pressure relief sense signal and the outgas sense signal to a control system external to the enclosure, where the forwarded pressure relief sense signal and the outgas sense signal may be analog discrete signals, for example. In some such embodiments, the processor may also transmit information associated with the pressure relief sense signal and the outgas sense signal to the control system, where the information is forwarded as a digital signal including an indication of the outgas event and/or the pressure release event, and may also include other relevant information such as time stamps of such events, measurements of gas pressure, and/or concentration of gases detected by the outgas sensor.

In some examples, the enclosure also includes a switch to selectively couple the plurality of battery cells to a load external to the enclosure. The switch may be controlled by the system external to the enclosure, and/or by the processor within the enclosure. In some such examples, during normal operation of the battery assembly (e.g., when no outgas event or pressure release event has been detected), the switch is in a closed state, and couples the battery cells to the load. However, responsive to a detection of an outgas event or a pressure release event, the switch transitions to an open state, and disconnects the battery cells form the load. Thus, upon detection of the outgas event or the pressure release event, the battery is not loaded, thereby reducing possibilities of thermal runaway and consequent reduction is possibilities of fire hazards. Numerous variations and embodiments will be apparent in light of the present disclosure.

### General Overview

As mentioned herein above, there remain several non-trivial issues with respect to operating lithium-ion battery packs. One challenge of lithium-ion battery technology is thermal management. An ongoing concern is the possibility of thermal runaway during use, handling, and/or transportation of lithium-ion batteries. Thermal runaway occurs when a series of self-sustaining exothermic side-reactions lead to total failure of the cell and, in some cases, fire and/or explosion. A battery cell undergoing a thermal runaway may emit hot gases, flames, and high-velocity jets of molten particulate matter, referred to as ejecta. Lithium-ion batteries have the potential to experience thermal runaway due to the chemical nature of the lithium-ion technology. Although significant progress has been made over time to improve cell performance (e.g., reducing capacity fade, increasing available power, etc.), challenges of thermal runaway and its propagation persist. For example, the materials and construction of individual battery cells or of the battery pack can result in a localized hot spot or heating that results in cell failure. Also, over-constraining a battery cell can result in large pressure gradients that lead to failure of mechanical components, such as plates and fasteners around a battery cell. Similarly, not letting the ejecta escape can lead to instantaneous formation of local hot spots that can trigger thermal runaway in nearby battery cells. Therefore, a need exists for structures and methodologies for mitigating the propagation of thermal runaway in lithium-ion battery packs.

Accordingly, techniques are described herein to form a battery assembly in which battery failure is detected at an early stage, and mitigating actions are taken in response to such detection, thereby preventing or at least reducing chances of thermal runaway and any consequent fire hazards in the battery assembly.

In some embodiment, the battery assembly comprises an enclosure that is substantially air-tight, and a plurality of battery cells within the enclosure. In some examples, the battery cells may be lithium ion battery cells, although other types of battery cells (such as lead acid batter cells or hydrogen cells) may also benefit from the techniques described herein.

During a faulty operation of a battery cell, gases may be released by the battery cell (referred to herein as “outgassing” of the battery cell), where examples of such released gases have been described herein below. Such released gases may increase gas pressure within the battery enclosure, and may aid in thermal runaway and fire hazard, as well as may cause structural damage to the enclosure. In one embodiment, a pressure relief device is mounted within the enclosure. In an example, the pressure relief device is a burst disc device, although other types of pressure relief device may also be used instead. The pressure relief device is configured to release gas pressure from the enclosure, e.g., by way of rupture of a diaphragm of the burst disc, responsive to the gas pressure exceeding a threshold due to outgassing of one or more battery cells during a fault condition.

In some embodiments, a pressure relief sensor within the enclosure is configured to output a pressure relief sense signal indicative of such a pressure relief event. For example, the pressure relief sense signal may change from a first voltage level to a second voltage level, in response to the pressure relief device releasing gas (e.g., by rupturing the diaphragm of the burst disc or by another appropriate manner).

In some embodiments, an outgas sensor within the enclosure is configured to sense any outgassing within the enclosure, e.g., due to a fault condition of one or more battery cells. The outgas sensor is configured to output an outgas sense signal, where the outgas sense signal may change from a one voltage level to another voltage level, in response to the outgas sensor detecting at least threshold amount of outgas within the enclosure. The outgas(es) detected by the outgas sensor may include gases emitted by the battery cells during faulty operation of the battery cells, where examples of such gases have been described herein below.

In some embodiments, a processor within the enclosure is configured to receive the pressure relief sense signal and the outgas sense signal. In some such embodiments, the processor may forward the pressure relief sense signal and the outgas sense signal to a control system external to the enclosure, where the forwarded pressure relief sense signal and the outgas sense signal may be analog discrete signals, for example. In some such embodiments, the processor may also transmit information associated with the pressure relief sense signal and the outgas sense signal to the control system, where the information is forwarded as a digital signal including an indication of the outgas event and/or the pressure release event, and may also include other relevant information such as time stamp of such events, measurements of gas pressure, and/or concentration of gases detected by the outgas sensor. The processor may transmit the information associated with the pressure relief sense signal and the outgas sense signal to the external system over a first communication link, such as a Controller Area Network (CAN) bus. The processor may transmit the discrete pressure relief sense signal and the outgas sense signal over a second communication link different from the first communication link.

In some examples, the enclosure also includes a switch to selectively couple the plurality of battery cells to a load external to the enclosure. In some such examples, the switch may be a contactor. The switch may be controlled by the system external to the enclosure, and/or by the processor within the enclosure. For example, the system and/or the processor generates one or more control signals, to control the operation of the switch.

During normal operation of the battery assembly (e.g., when no outgas event or pressure release event has been detected), the switch is in a closed state, and couples the battery cells to the load.

However, responsive to a detection of an outgas event or a pressure release event, the switch transitions to an open state, and disconnects the battery cells from the load. For example, responsive to a detection of an outgas event or a pressure release event, the control signal(s) generated by the system and/or the processor instructs the switch to transition to the open state. Thus, upon detection of the outgas event or the pressure release event, the battery is not loaded (due to the switch transitioning to the open state), thereby reducing possibilities of thermal runaway and consequent reduction in possibilities of fire hazards.

In accordance with some embodiments of the present disclosure, these various approaches can be used individually or together to mitigate or eliminate thermal runaway propagation in a battery pack assembly. Numerous variations and embodiments will be apparent in light of the present disclosure.

As used in the discussion and claims herein, the term “about” indicates that the value listed may be somewhat altered, as long as the alteration does not result in nonconformance of the process or device. For example, for some elements the term “about” can refer to a variation of +0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture

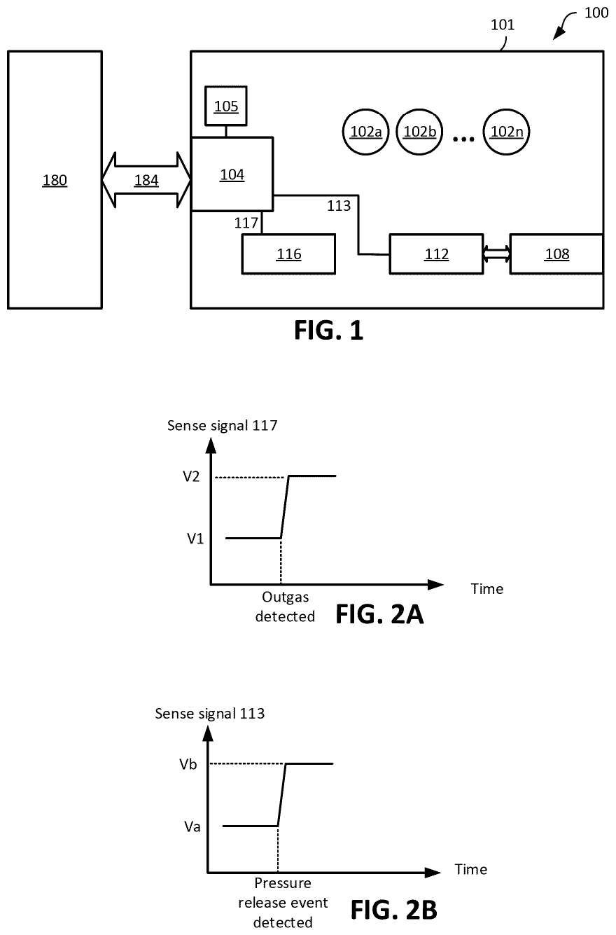

FIG. 1 illustrates a battery assembly 100 comprising a plurality of battery cells 102a, . . . , 102n within an enclosure 101, where the battery assembly 100 further includes (i) an outgas sensor 116 within the enclosure 101, the outgas sensor 116 configured to sense an outgas event of one or more battery cells 102 and output a first sense signal 117, (ii) a pressure relief device 108 within the enclosure 101, the pressure relief device 108 configured to release gas pressure from the enclosure 101, in response to pressure within the enclosure 101 exceeding a threshold value, (iii) a pressure relief sensor 112 configured to sense a pressure release event caused by the pressure relief device 108 and output a second sense signal 113, and (iv) a processor 104 configured to receive the first sense signal 117 and the second sense signal 113, and to transmit information associated with the first and second sense signals 113, 117 to a system 180 that is external to the enclosure 101, in accordance with an embodiment of the present disclosure.

In an example, the enclosure 101 is substantially air-tight. In one example, the enclosure 101 is fully air-tight or hermetically sealed. In another example, the enclosure 101 is substantially hermetically sealed, and may have minor gas leakages through the enclosure 101. However, even if there are minor gas leakages through the enclosure 101, such gas leakages may not be substantial and may not relieve or vent high gas pressure developed within the enclosure 101 due to a fault in one or more battery cells 102. In an example, such gas pressure may instead be relieved through the pressure relief device 108, as will be described herein in further detail. In some examples, the walls of the enclosure 101 comprise metal, while in some other examples the walls of the enclosure 101 comprise non-metal. In an example, the walls of the enclosure 101 comprise a combination of metal and non-metal.

In one embodiment, individual battery cells 102 may comprise of any appropriate type of battery cell. For example, individual battery cells 102 may comprise lithium ion battery cells, although the battery cells 102 may be of another appropriate type, such as lead acid battery cells, or hydrogen cells. In an example, the plurality of battery cells 102a, . . . , 102n may be coupled in series and/or parallel connection. In an example, the battery cells 102a, . . . , 102n may be of appropriate size and may have any appropriate shape or form factor. In one embodiment, each battery cell 102 includes an electrolyte within a corresponding container, although the electrolyte and the containers of the battery cells 102 are not illustrated in FIG. 1.

In an example, a battery cell 102 may fail, for example, due to overcharging, over-heating, excessive discharging, or another appropriate reason. In an example, out-gassing (also sometimes referred to as off-gassing) of a battery cell may occur during a beginning stage of battery failure. When out-gassing of the battery cell occurs, if no actions are taken to remedy the cause of the failure, the battery cell may proceed to thermal runaway, and may even burst into fire. In an example, out gassing may result from vapor of the battery cell electrolyte and/or other gas(es) generated within the batter cell, e.g., due to a fault condition within the battery cell. In such an example, such vapor and/or gas may be released out of the battery cell. Examples of gases released from lithium ion battery cells include hydrogen, methane, ethane, methylene, propylene, carbon monoxide, carbon dioxide, and/or organic carbonates, and the gases released from the battery cells may depend from the electrolyte and/or other materials used within the battery cells.

In one embodiment, the outgas sensor 116 is configured to detect an outgas event in one or more battery cells of the plurality of battery cells 102a, . . . , 102n. For example, the outgas sensor 116 is mounted proximal to the battery cells 103, and the outgas sensor 116 monitors the gas space inside the enclosure 101. The gas(es) monitored by the outgas sensor 116 may be based on the type of the battery cells 102 used in the assembly 100. For example, if the battery cells 102 comprise lithium ion battery cells, then the outgas sensor 116 may monitor for vapor of lithium ion battery electrolyte and/or other gases potentially generated by the battery cell during a fault condition. The outgas sensor 116 may detect gases from the battery cells 103 in parts per million (ppm) level detection threshold, for example.

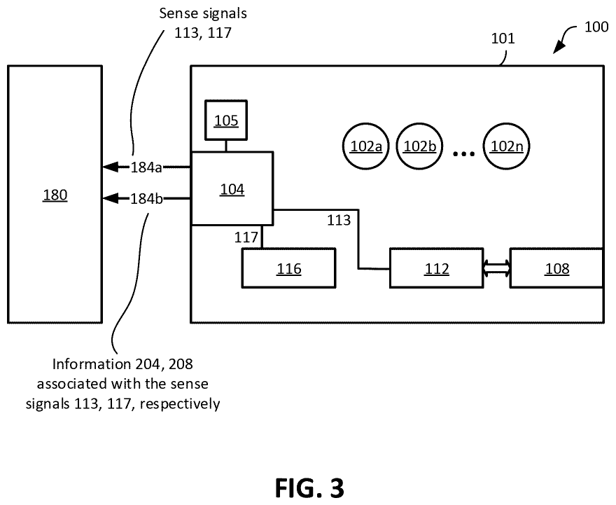

In one embodiment, the outgas sensor 116 outputs a sense signal 117. Once the outgas sensor 116 detects gas leakage from one or more battery cells 102 (e.g., detects an outgas event), the sense signal 117 is indicative of such a detection. For example, upon detecting an outgas event, the sense signal 117 changes from a first signal level to a second signal level. FIG. 2A illustrates a plot depicting the sense signal 117 output by the outgas sensor 116 of the battery assembly 100 of FIG. 1, in accordance with an embodiment of the present disclosure. The X-axis of the plot of FIG. 2A represents time and the Y axis of the plot represents the sense signal 117. For example, when no outgas event is detected, the outgas sensor 116 may output the sense signal 117 at a first voltage V1 (e.g., 0.50 V DC (direct current)). Upon detecting an outgas event, the outgas sensor 116 may output the sense signal 117 at a second voltage level V2 (e.g., 3.0 V DC). Thus, the sense signal 117 provides indication of the outgas event.

In one embodiment, during an outgas event, the gas pressure within the enclosure 101 increases, e.g., due to vaporization of the electrolyte of one or more of the battery cells 102a, . . . , 102n because of a fault condition within the one or more battery cells. In an example, the outgas sensor 116 detects such as outgas event, and indicates such detection through the sense signal 117 (e.g., by increasing the sense signal 117 from voltage V1 to voltage V2, see FIG. 2A). As will be described herein in turn in further detail, preventative actions may be taken (e.g., by the processor 104 and/or by the system 180), to remedy the situation causing the outgas event (e.g., by shutting down the battery cells 102a, . . . , 102n). However, in one example, the outgas detection and/or such remedial actions may not be sufficient or on time, and the gas pressure within the enclosure 101 may rise. Such rising gas pressure may cause thermal runaway, fire hazards, and/or structural damage to the enclosure 101.

Accordingly, in one embodiment, the pressure relief device 108 within the enclosure 101 releases gas pressure from the enclosure 101, e.g., in response to the gas pressure within the enclosure 101 exceeding a threshold value. In an example, the pressure relief device 108 is a burst disc or rapture disc mounted on a wall of the enclosure 101. A burst disc or a rupture disk is a pressure relief safety device that protects the system 100 from over pressurization and consequent fire hazards and/or structural damage. For example, the pressure relief device 108 has a non-reclosing, sacrificial part that is a one-time-use membrane or diaphragm. The diaphragm fails or ruptures at or above a predetermined differential pressure between the inside of the enclosure 101 and the ambient. For example, when the gas pressure inside of the enclosure 101 exceeds a threshold pressure, the diaphragm fails or ruptures (referred to herein as a pressure release event), thereby rapidly releasing the gas from within the enclosure 101, and thereby releasing or reducing the gas pressure within the enclosure 101. For example, the pressure relief device 108, when activated or ruptured, reduces the pressure within the enclosure 101 within a relatively small amount of time (e.g., within seconds or milliseconds or microseconds). In an example, once the diaphragm bursts, it may not be resealed, and the pressure relief device 108 may become non-operational until the diaphragm is repaired or replaced.

In one embodiment, the pressure relief sensor 112 senses a pressure release event caused by the pressure relief device 108. For example, the pressure relief sensor 112 outputs a sense signal 113 indicative of the pressure release event. In an example, the pressure relief sensor 112 may be integrated with the pressure relief device 108. For example, a rupture of the diaphragm of the pressure relief device 108 may be detected by the pressure relief sensor 112.

FIG. 2B illustrates a plot depicting the sense signal 113 output by the pressure relief sensor 112 of the battery assembly 100 of FIG. 1, in accordance with an embodiment of the present disclosure. The X-axis of the plot represents time and the Y axis of the plot represents the sense signal 113. For example, when no pressure release event is detected, the pressure relief sensor 112 may output the sense signal 113 at a first voltage Va (e.g., 0.50 V DC). Upon detecting a pressure release event, the pressure relief sensor 112 may output the sense signal 113 at a second voltage level Vb (e.g., 3.0 V DC). Thus, the sense signal 113 provides indication of the pressure release event.

In one embodiment, the sense signals 113 and 117 may be received by a processor 104 that is also within the enclosure 101. In an example, the processor 104 is a microcontroller. Although not illustrated, in an example, the processor 104 is coupled to a communication chip, e.g., for communicating with the sensors 116, 112 and/or for communicating with the system 180. In one embodiment, the processor 104 is coupled to a computer readable storage medium 105, such as a memory 105 or a data storage device 105 that is also within the enclosure 101. In one embodiment, the computer-readable storage medium 105 stores instructions or codes, which, when executed by the processor 104, cause the processor 104 to perform operations to protect the battery assembly 100 from various hazards, as described herein.

In one embodiment, the processor 104 and/or the memory 105 are on a printed circuit board (PCB), where the PCB is mounted within the enclosure 101. In an example, the PCB is mounted on a wall of the enclosure 101 that is as far as possible form another wall on which the pressure relief device 108 is installed (e.g., such that the processor 104 and/or the memory 105 are not damaged during the pressure release event). For example, the enclosure 101 has a first wall and an opposing second wall, where the PCB including the processor 104 and/or the memory 105 is mounted on the first wall, and the pressure relief device 108 is installed on the second wall, as illustrated in FIG. 1.

In one embodiment, the processor 104 receives the sense signals 113, 117, and transmits the sense signals 113, 117 and/or information associated therewith over communication link(s) 184 to the system 180 external to the enclosure 101.

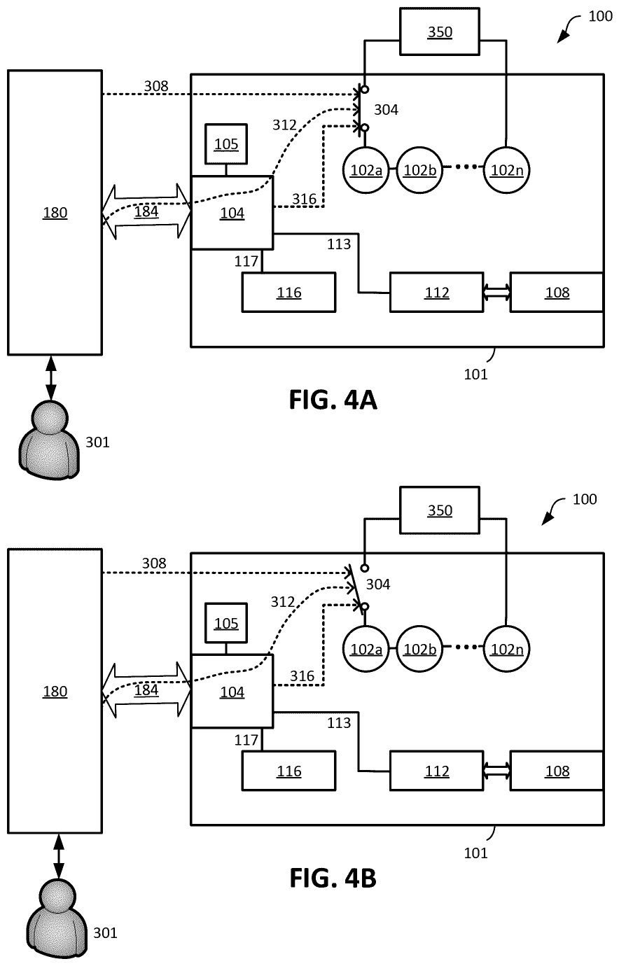

FIG. 3 illustrates further detail of communication between the processor 104 of the battery assembly 100 and the system 180 that is external to the enclosure 101, in accordance with an embodiment of the present disclosure. In the example of FIG. 3, the processor 104 transmits, over a first communication link 184a, the sense signals 113, 117. For example, the processor 104 doesn't alter or process the sense signals 113, 117, and merely retransmits or forwards the sense signals 113, 117, as received from the sensors 112, 116, respectively, to the system 180 over the communication link 184a. In an example, the retransmission of the sense signals 113, 117 may be performed by the processor 104, or by a dedicated hardware circuitry (not illustrated) that is coupled to the processor 104 and that receives and retransmits the sense signals 113, 117. In an example, the sense signals 113, 117 transmitted over the communication link 184a comprises discrete signals (e.g., has on and off states, or “0” and “1” states, or two states such as V1 and V2, or Va and Vb, see FIGS. 2A, 2B). In an example, the sense signals 113, 117 transmitted over the communication link 184a comprises analog signals.

In an example, the processor 104 may also transmit information 204, 208 associated with the sense signals 113, 117, respectively, to the system 180, e.g., over the communication link 184b, as illustrated in FIG. 3. In an example, the communication link 184b is a Controller Area Network (CAN) bus. For example, the processor 104 processes the sense signals 113, 117, and generates the information 204, 208, respectively. The processor transmits the information 204, 208 to the system 180 over the communication link 184b. For example, the information 204, 208 may include bits of data indicative of the outgas event and/or the pressure release event, if such an event has occurred.

In an example, the information 204, 208 may additionally include any other appropriate information. For example, the information 204, 208 may include time stamps of the associated events. In another example if the sense signal 117 provides a concentration level (e.g., in ppm) and/or type of gas detected by the outgas sensor 116, the information 204 may include such information.

Thus, in an example, the sense signals 113, 117 transmitted over the communicating link may be analog and/or discrete signal generated by the sensors 112, 116, respectively, and retransmitted by the processor 104. In contrast, the information 204, 208 associated with the sense signals 113, 117, respectively, may be digital data generated by the processor 104, based on the sense signals 113, 117.

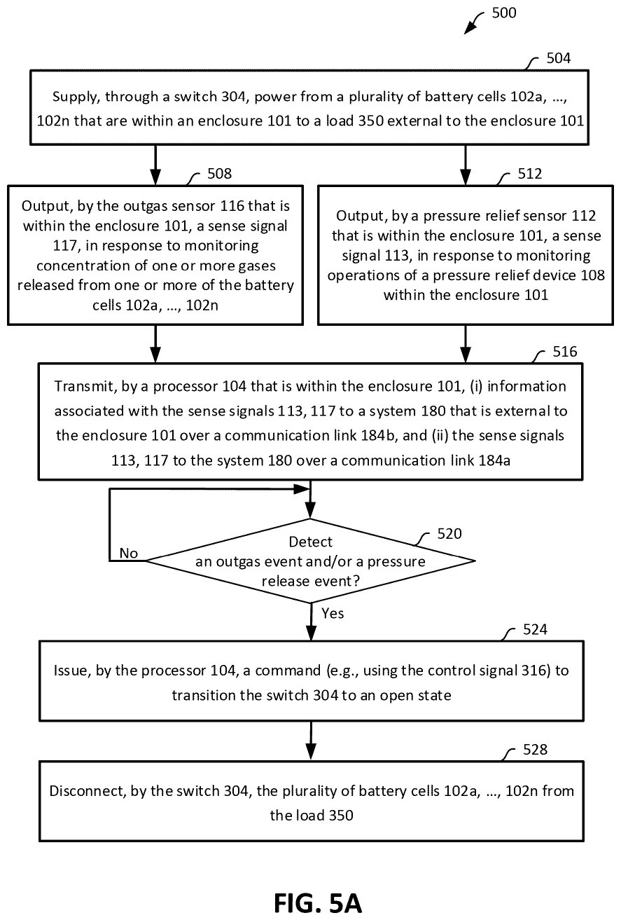

FIGS. 4A and 4B illustrate the battery assembly 100 of FIG. 1, along with operations of a switch 304 within the enclosure 101 of the battery assembly 100, where the switch 304 is operable to disconnect the plurality of battery cells 102a, . . . , 102n from a load 350 external to the enclosure 101, in response to detection of an outgas event and/or a pressure release event, in accordance with an embodiment of the present disclosure.

As illustrated in FIGS. 4A and 4B, the switch 304 couples the battery cells 102a, . . . , 102n to an external load 350 that is external to the enclosure 101. In an example, the switch 304 is a contactor, e.g., a device for making and breaking an electric circuit. The load 350 may be any appropriate type of load receiving DC power from the battery cells 102a, . . . , 102n.

In FIGS. 4A, 4B, the battery cells 102a, . . . , 102n are illustrated to be in series with the load 350, although this may not necessarily be the case. For example, a first battery cell may be parallel to a second battery cell, and the parallel combination may be in series with a third battery cell. Any other appropriate series/parallel combination of the battery cells 102a, . . . , 102n may also be possible.

The connection between the battery cells 102a, . . . , 102n and the load 350 is through the switch 304. Thus, when the switch 304 is closed (such as in FIG. 4A), the load 350 is coupled to the battery cells 102a, . . . , 102n. When the switch 304 is open (such as in FIG. 4B), the load 350 is disconnected from the battery cells 102a, . . . , 102n. Thus, FIG. 4A illustrates a closed state of the switch 304, e.g., when no outgas event and/or pressure release event is detected, such as during normal operation of the battery assembly 100. FIG. 4B illustrates an open state of the switch 304, e.g., when an outgas event and/or a pressure release event is detected.

In one embodiment, the switch 304 is controlled by one or more of control signals 308, 312, 316. Although FIG. 4A illustrates three control signals 308, 312, 316, the battery assembly 100 may have any single one, or any two, or all three control signals 308, 312, 316, based on an implementation of the battery assembly 100.

In an example, the control signal 308 is generated and transmitted by the system 180 to the switch 304, e.g., bypassing the processor 104. Thus, the control signal 308 may be transmitted from the system 180 to the enclosure 101 and the switch 304 using a communication link that is different from the communication links 184, 184a, 184b discussed with respect to FIGS. 1 and 3.

For example, the system 180 may receive the sense signals 113, 117 and/or may receive information 204, 208 associated with the sense signals 113, 117, respectively (e.g., over communication link 184), as discussed with respect to FIGS. 1 and 3. During normal operation of the battery assembly 100 (e.g., when no outgas event or pressure release event has been detected), the control signal 308 may indicate to the switch 304 to be in the closed state, as seen in FIG. 4A, such that the load 350 receives power from the battery cells 102a, . . . , 102n through the switch 304.

In one embodiment, in response to the sense signals 113, 117 and/or the information 204, 208 indicating an outgas event and/or a pressure release event, the system 180 may change a state of the control signal 308, e.g., to indicate to the switch 304 to switch from the closed state to an open state, as seen in FIG. 4B. In the open state of operation of the switch 304, the load 350 is disconnected from the battery cells 102a, . . . , 102n by the switch 304. Because the battery cells 102a, . . . , 102n are now disconnected from the load 350, the battery cells 102a, . . . , 102n are now not loaded, which eliminates or reduces chances of thermal runaway and fire hazard from the reason that caused the detected outgas event and/or the pressure release event.

In an example, the control signal 312 is generated and transmitted by the system 180 to the switch 304, through the processor 104. Thus, while the control signal 308 is transmitted by the system 180 to the switch 304 directly (e.g., by bypassing the processor 104), the control signal 312 is transmitted by the system 180 to the switch 304 through the processor 104. For example, the control signal 312 is transmitted by the system 180 to the processor 104 through the communication link 184 discussed with respect to FIG. 1, and then the processor 104 transmits the control signal 312 to the switch 304. In an example, the system 180 transmits either the control signal 308 or the control signal 312 to the switch 304.

In an example, the control signal 316 is generated and transmitted by the processor 104 to the switch 304, e.g., based on the processor 104 receiving the analyzing the sense signals 113, 117. Operation of the control signal 316 may be at least in part similar to the operation of the control signal 308 described above.

Thus, any one or both the processor 104 or the system 180 may control the switch 304, e.g., using one or more of the control signals 308, 312, or 316. In one embodiment and as discussed above, the system 180 may automatically control the switch 304 through the control signals 308 and/or 312. In another example, a user 301 may interact with the system 180, e.g., to be informed about the sense signals 113, 117 and/or associated information 204, 208. In one embodiment, there may be a manual override that can be used by the user 301 to override the automatic controlling of the switch 304, and the user 301 may manually control the switch 304, e.g., through the system 180.

In an example, battery assembly 100 may be installed in a vehicle, such as a hybrid electric vehicle (HEV) or a battery electric vehicle (BEV), including a personal vehicle, such as a scooter, a car, a motorcycle, or a truck, or a commercial vehicle such as a truck or bus, a maritime vehicle such as a boat, Unmanned underwater vehicles (UUV) or submarine, or a military vehicle such as a tank, a self-propelled artillery, or a troop transport. In an example, the battery assembly 100 may be installed in an aircraft such as an airplane or a helicopter, an unmanned aerial vehicle (UAV), a missile system, a space craft, or another powered air vehicle.

For example, if the battery assembly 100 is installed in a vehicle (such as an aircraft), the battery assembly 100 has to adhere to various rigorous standards applicable to such a sensitive installation. Such installation of the battery assembly 100 may necessitate low probability of thermal runaway of the battery assembly 100 and consequent low probability of fire hazards. In one embodiment, use of the outgas sensor 116, as well as the pressure relief device 108 and the pressure relief sensor 112, may ensure that outgas events and/or pressure relief events are detected in time, e.g., prior to occurrence of thermal runaway. Delivering warnings well ahead of thermal runaway using the sense signals 113, 117, and taking automatic actions such as opening of the switch 304, enables prevention or reduction of probability of thermal runaway events and consequent possibilities of fire hazards in the battery assembly 100.

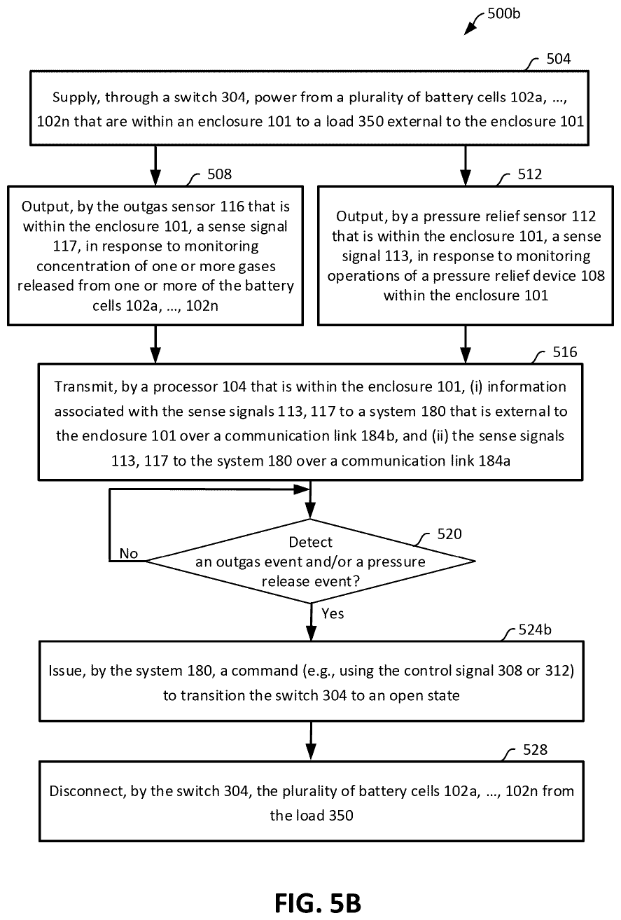

FIG. 5A illustrate a flowchart depicting a method 500 for operating the battery assembly 100 of FIGS. 1, 3, 4A, and 4B, where a switch 304 for connecting and disconnecting the plurality of battery cells 102a, . . . , 102n to a load 350 is controlled by the processor 104 that is within the enclosure 101, in accordance with an embodiment of the present disclosure. At 504 of the method 500, power is supplied, through the switch 304, from the plurality of battery cells 102a, . . . , 102n that are within an enclosure 101 to the load 350 external to the enclosure 101, e.g., as illustrated in FIG. 4A. For example, in FIG. 4A, the switch 304 is at the closed state, thereby supplying power from the plurality of battery cells 102a, . . . , 102n to the load 350.

The method 500 continues from 504 to 508 and 512. At 508, the outgas sensor 116, which is within the enclosure 101, outputs the sense signal 117, in response to monitoring concentration of one or more gases released from one or more of the battery cells 102a, . . . , 102n. For example, one or more gases includes vapor of electrolyte within a battery cell and/or other gas(es) generated by the battery cell during a fault condition, which may be released from the battery cell during the fault condition in the battery cell. If the gas concentration exceeds a threshold level, the outgas sensor 116 detects an outgas event, and provides an indication of the outgas event through the sense signal 117, e.g., as discussed with respect to FIG. 2A.

At 512, the pressure relief sensor 112, which is also within the enclosure 101, outputs the sense signal 113, in response to monitoring operations of the pressure relief device 108 within the enclosure 101. For example, if gas pressure within the enclosure 101 exceeds a threshold value, the pressure relief device 108 (e.g., which is a burst disc in one example) releases gas, e.g., by rupturing the diaphragm or disc of the burst disc device. In response to such a pressure release event, the pressure relief sensor 112 provides an indication of the pressure release event through the sense signal 113, e.g., as discussed with respect to FIG. 2B.

The method 500 proceeds from 508 and 512 to 516, where the processor 104, which is also within the enclosure 101, transmits (i) information associated with the sense signals 113, 117 to the system 180 that is external to the enclosure 101 over the communication link 184b, and (ii) the sense signals 113, 117 to the system 180 over the communication link 184a, e.g., as discussed in further detail with respect to FIG. 3.

The method 500 proceeds from 516 to 520, where the processor 104 and/or the system 180 detect if an outgas event and/or a pressure release event has occurred, e.g., based on the sense signals 113, 117 and/or the information associated with the sense signals 113, 117. If “No” at 520 (e.g., no outgas event and/or pressure release event has been detected), the method 500 loops back at 520, where the processor 104 and/or the system 180 continues to perform the detection. Note that the operations at 504, 508, 512, 516, and 520 occur continuously during regular or normal operation of the battery assembly 100, e.g., until a positive detection has been made at process 520.

If “Yes” at 520 (e.g., an outgas event and/or a pressure release event has been detected), the method 500 proceeds from 520 to 524. At 524, the processor 104 issues a command (e.g., using the control signal 316) to transition the switch 304 from the current closed state to an open state. For example, the control signal 316 transitions from one voltage level to another voltage level, indicating to the switch 304 to transition to the open state.

The method 500 proceeds from 524 to 528, where the switch 304 transitions to the open state and disconnects the plurality of battery cells 102a, . . . , 102n from the load 350, based on the command received via the control signal 316 from the processor 104 (see process 524 of method 500), e.g., as also discussed with respect to FIG. 4B herein above.

Thus, responsive to the detection of the outgas event and/or the pressure release event, disconnection of the load 350 from the battery cells 102a, . . . , 102n prevents or reduces chances of thermal runaway in one or more battery cells, thereby preventing or reducing chances of fire hazard in the battery assembly 100.

FIG. 5B illustrate a flowchart depicting a method 500b for operating the battery assembly 100 of FIGS. 1, 3, 4A, and 4B, where the switch 304 for connecting and disconnecting the plurality of battery cells 102a, . . . , 102n to the load 304 is controlled by the system 180 that is external to the enclosure 101, in accordance with an embodiment of the present disclosure.

Various processes of the method 500b of FIG. 5B are similar to corresponding processes of the method 500 of FIG. 5A, and similar processes in both methods are labelled using the same label. However, process 524 of the method 500 of FIG. 5A was performed by the processor 104 that is within the enclosure 101. In contrast, in the method 500b of FIG. 5B, a corresponding process 524b may be performed by the system 180 that is external to the enclosure 101.

For example, from 520 where an outgas event and/or a pressure release event is detected, the method 500b of FIG. 5B proceeds to 524b. At 524b, the system 180 issues a command (e.g., using the control signal 308 or 312, see FIG. 3) to transition the switch 304 from the current closed state to an open state. For example, the control signal 308 or 312 transitions from one voltage level to another voltage level, indicating to the switch 304 to transition to the open state. The method 500b proceeds from 524b to 528, which has been discussed with respect to FIG. 5A.

Thus, in one example and as discussed above with respect to 524 of FIGS. 5A and 524b of FIG. 5B, the processor 104 or the system 180 may automatically control the switch 304, through the control signals 308, 312, or 316. In another example, both the processor 104 and the system 180 may respectively issue commands to the switch 304, to transition to the open state, e.g., which is a combination of processes 524 and 524b of FIGS. 5A and 5B.

In yet another example, in addition to, or instead of, the processor 104 and/or the system 180 automatically controlling the switch 304, the user 301 (see FIG. 3) may manually control the switch 304. For example, the user 301 may interact with the system 180 and/or the processor 104, e.g., to be informed about the sense signals 113, 117 and/or associated information 204, 208. In one embodiment, there may be a manual override that can be used by the user 301 to override the automatic controlling of the switch 304 by the processor 104 and/or the system 180, and the user 301 may manually control the switch 304, e.g., through the system 180 and/or the processor 104.

### Further Example Embodiments

The following examples pertain to further embodiments, from which numerous permutations and configurations will be apparent.

Example 1. A battery assembly comprising: an enclosure; an outgas sensor within the enclosure, the outgas sensor configured to sense an outgas event of one or more battery cells within the enclosure and output a first sense signal; a pressure relief device within the enclosure, the pressure relief device configured to release gas pressure from the enclosure, in response to pressure within the enclosure exceeding a threshold value; a pressure relief sensor within the enclosure, the pressure relief sensor configured to sense a pressure release event caused by the pressure relief device and output a second sense signal; and a processor within the enclosure, the processor configured to receive the first sense signal and the second sense signal, and to transmit information associated with the first and second sense signals to a system that is external to the enclosure.

Example 2. The battery assembly of example 1, wherein the pressure relief device is a burst disc, wherein the pressure release event is a burst disc event in which a disc of the burst disc bursts, and wherein the pressure relief sensor is a burst disc sensor configured to provide indication of the burst disc event within the second sense signal.

Example 3. The battery assembly of any one of examples 1-2, further comprising: a plurality of battery cells within the enclosure including the one or more battery cells; and a switch within the enclosure, wherein the plurality of battery cells is coupled via the switch to a circuit external to the enclosure; wherein responsive to receiving a control signal generated in response to the first sense signal indicating the outgas event and/or the second sense signal indicating the pressure release event, the switch is configured to disconnect the plurality of battery cells from the circuit external to the enclosure.

Example 4. The battery assembly of example 3, wherein the control signal is generated by the processor.

Example 5. The battery assembly of example 3, wherein the control signal is generated by the system external to the enclosure, and is transmitted to the switch through the processor.

Example 6. The battery assembly of example 3, wherein the control signal is generated by the system external to the enclosure, and is transmitted to the switch bypassing the processor.

Example 7. The battery assembly of any one of examples 1-6, wherein the processor is further configured to forward the first and second sense signals to the external system, in addition to transmitting the information associated with the first and second sense signals to the external system.

Example 8. The battery assembly of example 7, wherein: the first and second sense signals forwarded by the processor to the external system are analog discrete signals; and the information associated with the first and second sense signals transmitted by the processor to the external system comprises a digital signal.

Example 9. The battery assembly of any one of examples 1-8, wherein the information associated with the first sense signal comprises an indication of the outgas event, and the information associated with the second sense signal comprises an indication of the pressure release event.

Example 10. The battery assembly of any one of examples 1-9, wherein the information associated with the first sense signal comprises a sensed concentration of the outgas and a time stamp of the outgas event.

Example 11. The battery assembly of any one of examples 1-10, wherein the outgas sensor is to sense the outgas event, in response to detecting at least a threshold level of one or more gases emitted by the one or more battery cells.

Example 12. The battery assembly of example 11, wherein the one or more gases include vapor of lithium ion battery electrolyte solvent.

Example 13. The battery assembly of any one of examples 1-12, wherein the one or more battery cells include one or more lithium-ion battery cells.

Example 14. The battery assembly of any one of examples 1-13, wherein: the enclosure has a first wall and an opposing second wall; the processor is on a printed circuit board (PCB) that is mounted on the first wall; and the pressure relief device is mounted on the second wall, such that during the pressure release event, pressure is released through an opening of the pressure relief device.

Example 15. A method of operating a battery assembly, the method comprising: outputting, by an outgas sensor that is within an enclosure, a first sense signal, in response to monitoring concentration of one or more gases from one or more battery cells that are within the enclosure; outputting, by a pressure relief sensor that is within the enclosure, a second sense signal, in response to monitoring operations of a pressure relief device within the enclosure; and transmitting, by a processor that is within the enclosure, information associated with the first and second sense signals to a system that is external to the enclosure.

Example 16. The method of example 15, further comprising: connecting, through a switch that is within the enclosure, a plurality of battery cells to a load that is external to the enclosure, the plurality of battery cells within the enclosure and including the one or more battery cells; and disconnecting, by the switch, the plurality of battery cells from the load, responsive to receiving a control signal generated in response to the first sense signal indicating an outgas event and/or the second sense signal indicating a pressure release event.

Example 17. The method of example 16, further comprising: generating, by the system that is external to the enclosure and/or by the processor system that is within the enclosure, the control signal, based on monitoring the first and second signals and/or the information associated with the first and second sense signals.

Example 18. A battery assembly comprising: an enclosure; a plurality of battery cells within the enclosure; one or more sensors configured to monitor for one or more events associated with the plurality of battery cells; and a processor within the enclosure, the processor configured to (i) receive the one or more sense signals from the one or more sensors, (ii) transmit, over a first communication link, information associated with the one or more sense signals to a system that is external to the enclosure, and (iii) forward, over a second communication link different from the first communication link, the one or more sense signals to the system that is external to the enclosure.

Example 19. The battery assembly of example 18, wherein: the one or more sensors comprise (i) an outgas sensor configured to sense an outgas event of one or more battery cells of the plurality of battery cells, and (ii) a pressure relief sensor configured to sense a pressure release event caused by a pressure relief device that is within the enclosure.

Example 20. The battery assembly of any one of examples 18-19, wherein: the information associated with the one or more sense signals comprises a digital signal transmitted over a Controller Area Network (CAN) bus to the system; and the one or more sense signals forwarded to the system comprises analog discrete signals transmitted over a bus that is different from the CAN bus.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A battery assembly comprising:
an enclosure;
an outgas sensor within the enclosure, the outgas sensor configured to sense an outgas event of one or more battery cells within the enclosure and output a first sense signal;
a pressure relief device within the enclosure, the pressure relief device configured to release gas pressure from the enclosure, in response to pressure within the enclosure exceeding a threshold value;
a pressure relief sensor within the enclosure, the pressure relief sensor configured to sense a pressure release event caused by the pressure relief device and output a second sense signal; and
a processor within the enclosure, the processor configured to receive the first sense signal and the second sense signal, and to transmit information associated with the first and second sense signals to a system that is external to the enclosure.

2. The battery assembly of claim 1, wherein the pressure relief device is a burst disc, wherein the pressure release event is a burst disc event in which a disc of the burst disc bursts, and wherein the pressure relief sensor is a burst disc sensor configured to provide indication of the burst disc event within the second sense signal.

3. The battery assembly of claim 1, further comprising:
a plurality of battery cells within the enclosure including the one or more battery cells; and
a switch within the enclosure, wherein the plurality of battery cells is coupled via the switch to a circuit external to the enclosure;
wherein responsive to receiving a control signal generated in response to the first sense signal indicating the outgas event and/or the second sense signal indicating the pressure release event, the switch is configured to disconnect the plurality of battery cells from the circuit external to the enclosure.

4. The battery assembly of claim 3, wherein the control signal is generated by the processor.

5. The battery assembly of claim 3, wherein the control signal is generated by the system external to the enclosure, and is transmitted to the switch through the processor.

6. The battery assembly of claim 3, wherein the control signal is generated by the system external to the enclosure, and is transmitted to the switch bypassing the processor.

7. The battery assembly of claim 1, wherein the processor is further configured to forward the first and second sense signals to the external system, in addition to transmitting the information associated with the first and second sense signals to the external system.

8. The battery assembly of claim 7, wherein:
the first and second sense signals forwarded by the processor to the external system are analog discrete signals; and
the information associated with the first and second sense signals transmitted by the processor to the external system comprises a digital signal.

9. The battery assembly of claim 1, wherein the information associated with the first sense signal comprises an indication of the outgas event, and the information associated with the second sense signal comprises an indication of the pressure release event.

10. The battery assembly of claim 1, wherein the information associated with the first sense signal comprises a sensed concentration of the outgas and a time stamp of the outgas event.

11. The battery assembly of claim 1, wherein the outgas sensor is to sense the outgas event, in response to detecting at least a threshold level of one or more gases emitted by the one or more battery cells.

12. The battery assembly of claim 11, wherein the one or more gases include vapor of lithium ion battery electrolyte solvent.

13. The battery assembly of claim 1, wherein the one or more battery cells include one or more lithium-ion battery cells.

14. The battery assembly of claim 1, wherein:
the enclosure has a first wall and an opposing second wall;
the processor is on a printed circuit board (PCB) that is mounted on the first wall; and
the pressure relief device is mounted on the second wall, such that during the pressure release event, pressure is released through an opening of the pressure relief device.

15. A method of operating a battery assembly, the method comprising:
outputting, by an outgas sensor that is within an enclosure, a first sense signal, in response to monitoring concentration of one or more gases from one or more battery cells that are within the enclosure;
outputting, by a pressure relief sensor that is within the enclosure, a second sense signal, in response to monitoring operations of a pressure relief device within the enclosure; and
transmitting, by a processor that is within the enclosure, information associated with the first and second sense signals to a system that is external to the enclosure.

16. The method of claim 15, further comprising:
connecting, through a switch that is within the enclosure, a plurality of battery cells to a load that is external to the enclosure, the plurality of battery cells within the enclosure and including the one or more battery cells; and
disconnecting, by the switch, the plurality of battery cells from the load, responsive to receiving a control signal generated in response to the first sense signal indicating an outgas event and/or the second sense signal indicating a pressure release event.

17. The method of claim 16, further comprising:
generating, by the system that is external to the enclosure and/or by the processor system that is within the enclosure, the control signal, based on monitoring the first and second signals and/or the information associated with the first and second sense signals.

18. A battery assembly comprising:
an enclosure;
a plurality of battery cells within the enclosure;
one or more sensors configured to monitor for one or more events associated with the plurality of battery cells; and
a processor within the enclosure, the processor configured to (i) receive the one or more sense signals from the one or more sensors, (ii) transmit, over a first communication link, information associated with the one or more sense signals to a system that is external to the enclosure, and (iii) forward, over a second communication link different from the first communication link, the one or more sense signals to the system that is external to the enclosure.

19. The battery assembly of claim 18, wherein:
the one or more sensors comprise (i) an outgas sensor configured to sense an outgas event of one or more battery cells of the plurality of battery cells, and (ii) a pressure relief sensor configured to sense a pressure release event caused by a pressure relief device that is within the enclosure.

20. The battery assembly of claim 18, wherein:
the information associated with the one or more sense signals comprises a digital signal transmitted over a Controller Area Network (CAN) bus to the system; and
the one or more sense signals forwarded to the system comprises analog discrete signals transmitted over a bus that is different from the CAN bus.
